(19) United States
(12) Patent Application Publication
(10) Pub. No.: US 2007/0101438 A1
(43) Pub. Date: May 3, 2007

(54) Location-based authentication

(76) Inventor: Gunasekaran Govindarajan, Santa Clara, CA (US)

Correspondence Address: William L. Botger, PO Box 478, Center Moriches, NY, 11934, US

(21) Appl. No.: 11/586,932

(22) Filed: Oct. 26, 2006

Related U.S. Application Data
(60) Provisional application No. 60/730,816, filed on Oct. 28, 2005.

(51) Int. Cl. H04L 9/32

(52) U.S. Cl. 726/27

(57) ABSTRACT

A method and system to configure data, such that access to data is protected based on a location. Once the data is configured, it can only be accessed from authorized locations, which are locations from which the location protected data is allowed to be accessed. Moreover, the location protected data is encrypted by using Data Encryption Keys (DEKs). DEKs are encrypted by using the authorized location information. A method and system for managing access to the location protected data is also disclosed. A request is received to access the location protected data from a location. Access to the location protected data is granted when the location is an authorized location. Once access is granted, DEKs are retrieved and the location protected data is decrypted. DEKs are periodically replaced with newly generated DEKs.

### CROSS REFERENCE TO RELATED APPLICATION

This application claims priority of U.S. Provisional application Ser. No. 60/730,816, filed on Oct. 28, 2005, entitled “Methods of Using Location Information to Restrict Access to File Systems and Data”, the content of which is incorporated herein by reference in its entirety.

### BACKGROUND

The present invention relates to the field of data security. More particularly, it relates to a method and system for providing access to location protected data, present on a computational device, based on the geographical location from which a request to access the location protected data is initiated.

A network is formed by connecting a plurality of computational devices. Examples of a computational device include, but are not limited to, a personal computer, a laptop, a personal digital assistant (PDA), a mobile phone and any electronic device with a micro-controller. A computational device stores data on a storage device. Examples of a storage device include, but are not limited to, a hard disk, a compact disk, a pen drive, a floppy disk, and a magnetic tape. With technological development computational devices have become capable of accessing data from different geographical locations. The data may be confidential data such as military information, personal information, a research report and the like. Access to the data from unauthorized locations needs to be restricted. When a computational device is connected in a network, the data can be accessed from other computational devices connected to the network. Examples of a network include, but are not limited to, the Internet, an Extranet, an Ethernet, a Local Area Network (LAN), a Personal Area Network (PAN), a Wide Area Network (WAN), a Campus Area Network (CAN), a Metropolitan Area Network (MAN), a Global System Mobile (GSM) network, and a Code Division Multiple Access (CDMA) network. It becomes even more important to restrict access to the data present on the network when the data is accessed from different geographical locations.

There exist various methods to control the access to data stored on a computational device. U.S. Pat. No. 7,000,116, titled “Password value based on geographic location”, describes the use of distinct passwords for different geographical locations to restrict access the computational device that stores the data.

U.S. Pat. No. 5,757,916, titled “Method and apparatus for authenticating the location of remote users of networked computing systems”, describes a method and system for authenticating access to an electronic device that stores the data.

U.S. Pat. No. 7,080,402, titled “Access to applications of an electronic processing device solely based on geographic location”, illustrates the use of a username, a password and the location (latitude and longitude) based authentication to control access to various applications (computer program) that uses the data. Examples of applications can include word-processing software, email software, picture viewing software, database server, search engines and the like.

One or more of the above-mentioned methods attempt to restrict access to the data by restricting access to a computational device itself and/or by restricting access to an application running on the computational device. However, an unauthorized user can still access the data by bypassing the access to the computational device and/or by bypassing the access to the application. For example, access to a computer can be restricted but its storage device can be plugged in another computational device to access the data.

Further, if an unauthorized user obtains the authorization information such as the username, and the password, the unauthorized user can access the computational device and/or the application and can hence the data.

Therefore, there exists a need for a method and system to restrict unauthorized access to the data stored on a computational device from an un-authorized location. Further, there is a need for a method and system to restrict unauthorized access to the data by reusing previously obtained authorization information such as username and password. Also there exists a need for a method and system to restrict unauthorized access to the data based on location information, even if access to the computational device is gained with proper username and password.

### SUMMARY

An object of the invention is to restrict unauthorized access to the location protected data stored on a computational device from an unauthorized location.

Another object of the present invention is to restrict unauthorized access to the location protected data, even if access to the computational device at which the location protected data is stored, is obtained.

Yet another object of the present invention is to restrict access to location protected data with a previously obtained authorization.

In accordance with the above-mentioned objects, and those mentioned below, the present invention comprises a method for managing access to location protected data on a first computational device. The location protected data can only be accessed from an authorized location. When a second computational device makes a request to access the location protected data from an authorized location, an Authorized Location Key (ALK) corresponding to the authorized location is retrieved. The authorized location is the location from which the location protected data is allowed to be accessed. The ALK is used to retrieve the Data Encryption Key (DEK). The DEK is used to decrypt the location protected data. Access to the location protected data is then provided to the second computational device. DEK and ALK are not exposed to users of the second computational device.

In accordance with the above-mentioned objects, and those mentioned below, the present invention comprises a method for configuring access to location protected data on a first computational device. The location protected data is encrypted by using a DEK. The DEK is encapsulated in a key ring. The key ring is encrypted by using at least one Administrative Public Key (APK). The key ring is further encrypted by using at least one ALK. Authorized locations are associated with at least one ALK. Access to the location protected data is authorized to second computational device requesting access from an authorized location. The DEK and the ALK are not exposed to users of the second computational device who try to access the location protected data. Once access to the location protected data is configured the location protected data can be accessed only from authorized locations by authorized users. Even if a storage device containing the location protected data is lost or stolen, no one can access the location protected data.

In accordance with the above-mentioned objects, and those mentioned below, the present invention comprises a data protection system for managing access to location protected data on a first computational device. The system comprises a request receiving module, a key-retrieving module, an encryption-decryption module, and a control module. The request receiving module receives a request from a second computational device to access the location protected data. The key-retrieving module retrieves an ALK corresponding to a location of the second computational device when the location of the second computational device is an authorized location. Access to the location protected data is authorized only if the location of the second computational device is an authorized location. The key-retrieving module retrieves a DEK. The encryption-decryption module decrypts the location protected data using the DEK. DEK and ALK are not exposed to users of the second computational device. The control module enables access to the location protected data.

In accordance with the above-mentioned objects, and those mentioned below, the present invention comprises a method for changing DEKs and ALKs by using randomization techniques when access to the location protected data is discontinued. The invention further comprises a method for changing DEKs and ALKs at a preconfigured interval.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 illustrates an environment where various embodiments of the invention can be practiced;

FIG. 2 is a block diagram of a data protection system, in accordance with an embodiment of the invention;

FIG. 3 is a flow diagram illustrating a method for managing access to location protected data on a first computational device, in accordance with an embodiment of the invention;

FIG. 4 is a flow diagram illustrating a method for managing access to location protected data on a first computational device, in accordance with another embodiment of the invention;

FIG. 5 is a flow diagram illustrating a method for terminating access to location protected data on a first computational device, in accordance with an embodiment of the invention;

FIG. 6 is a flow diagram illustrating a method for configuring access to location protected data, in accordance with an embodiment of the invention;

FIG. 7 illustrates an exemplary authentication configuration table, in accordance with an embodiment of the invention;

FIG. 8 illustrates an exemplary key table in accordance with an embodiment of the invention; and

FIG. 9 illustrates a key ring, in accordance with an embodiment of the invention.

### DESCRIPTION OF PREFERRED EMBODIMENTS

The present invention provides a method and system for managing access to location protected data on a first computational device. When a request is made to access the location protected data from an authorized location, an Authorized Location Key (ALK) is retrieved. The ALK further decrypts a Data Encryption Key (DEK). Thereafter, the location protected data is decrypted by using the DEK. DEK and ALK are not exposed to users who try to access the location protected data.

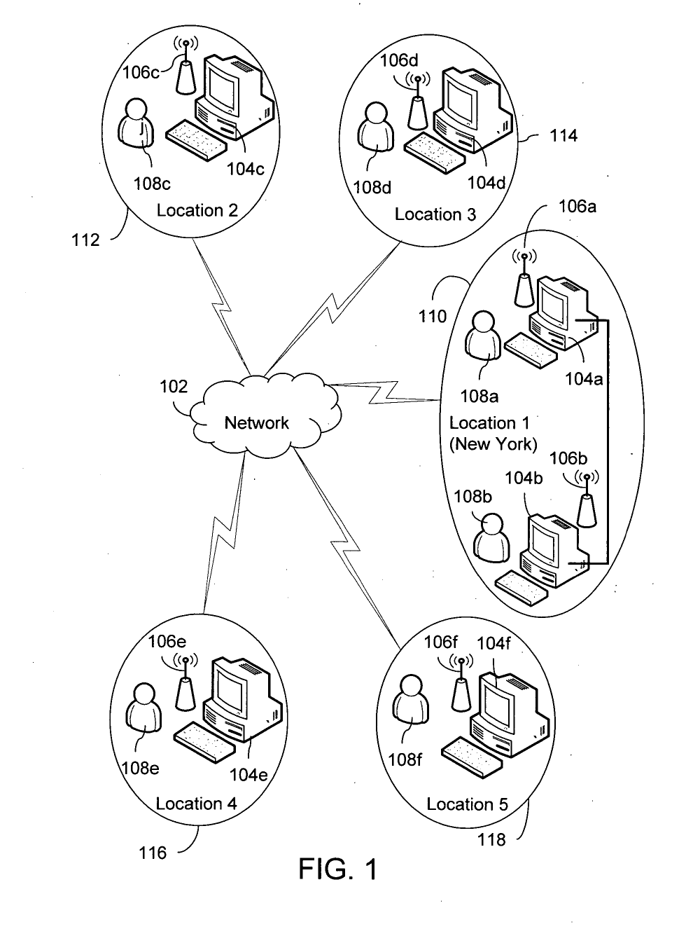

FIG. 1 illustrates an environment 100 where various embodiments of the invention can be practiced. Environment 100 includes a network 102. Examples of network 102 include, but are not limited to, the Internet, an Ethernet, a Local Area Network (LAN), a Wide Area Network (WAN), a Metropolitan Area Network (MAN), a Global System Mobile (GSM) network, and a Code Division Multiple Access (CDMA) network. Network 102 includes a plurality of computational devices such as computational devices 104a, 104b, 104c, 104d, 104e, and 104f. Examples of a computational device include, but are not limited to, a personal computer, a laptop, a personal digital assistant (PDA), and a cellular phone. Computational devices 104a and 104b are connected to each other in an internal network at a geographical location, for example New York. The internal network can be a LAN network in an organization. Further, computational devices 104c, 104d, 104e, and 104f may be located at different locations say Seattle, Dallas, Chicago, and California, respectively.

A location provider provides location information of a user situated at a geographical location. For example, location providers 106a, 106b, 106c, 106d, 106e, and 106f provide location information of computational devices 104a, 104b, 104c, 104d, 104e, and 104f, respectively. Examples of a location provider include, but are not limited to a Global Positioning System (GPS) enabled system, a hardware module, a software module, and a combination of a hardware module and a software module. Location information includes details such as the latitude, the longitude, the altitude and the area of the location and is transmitted through Network 102 so that the location of the person requesting the data may be ascertained.

A user accesses the data from a geographical location. For example, users 108a and 108b situated at location 110 access data on computational devices at other locations by using computational device 104a and 104b, respectively. Similarly, users 108c, 108d, 108e, and 108f access the data on network 102 from locations 112, 114, 116, and 118 using different computational devices as shown in FIG. 1.

The plurality of computational devices may contain data and/or information. The data and/or information can be stored on a storage device connected to a computational device. Examples of a storage device include, but are not limited to, a hard disk, a compact disk, a pen drive, a floppy disk, a magnetic tape. The storage device may be at least one of a removable and a non-removable storage device. The data and/or information on one computational device can be accessed through another computational device through network 102. The data and/or information stored on the storage device may be at least one of a location protected data and unprotected data. The location protected data can only be accessed from authorized locations while the unprotected data may be accessed from any location. The location protected data is secured using authorized location information.

Hereinafter, computational devices 104c and 104d are referred to as a first computational device and a second computational device respectively for explanation purposes.

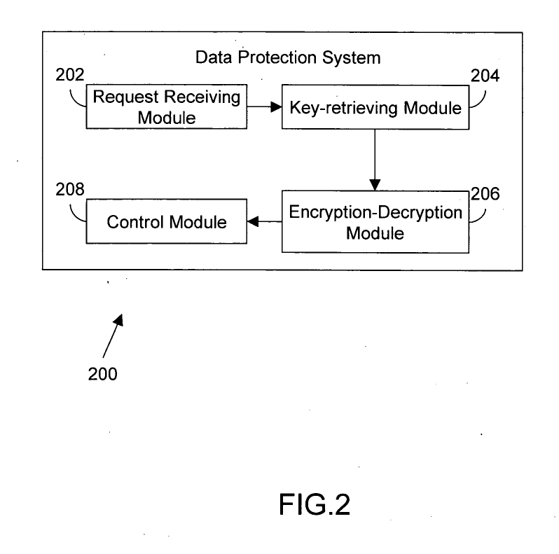

FIG. 2 is a block diagram of a data protection system 200, in accordance with an embodiment of the invention.

It should be noted that the invention is described with reference to the first computational device and the second computational device for the sake of clarity; however the invention can be implemented with reference to any other computational device. In an embodiment of the invention the first computational device and the second computational device may be same.

Data protection system 200, at the first computational device, includes a request receiving module 202, a key-retrieving module 204, an encryption-decryption module 206 and a control module 208. Data protection system 200 further comprises means for preventing the data encryption key and the authorized location key from being exposed to the second computational device. Request receiving module 202 can receive a request to access location protected data stored at the first computational device. The location protected data can only be accessed from authorized locations. The request can be received from a second computational device. For example, a user may attempt to access data stored on a server on the Internet using a laptop.

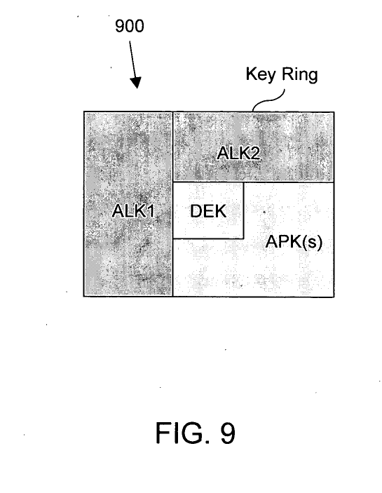

When the location of the second computational device is an authorized location as determined from the location data, key-retrieving module 204 retrieves an ALK corresponding to a location of the second computational device. Control module 208 receives the location of the second computational device from a location provider situated at the location of the second computational device. For example, location provider 106c provides the location of computational device 104c. The authorized location is the location form where the location protected data can be accessed. For example, the location protected data stored at the first computational device at New York can be configured to have access only from Dallas and not from California. Further, key-retrieving module 204 retrieves a DEK from a key ring. The key ring encapsulates the DEK. The key ring is described in further details in conjunction with FIG. 9

Encryption-decryption module 206 decrypts (or encrypts) the key ring by using the ALK to retrieve the DEK. The DEK is used to decrypt (or encrypt) the location protected data. Moreover, the DEK and the ALK are not exposed to users of the second computational device. In an embodiment of the invention, the encryption-decryption module 206 encrypts the key ring by using at least one ALK and an administrative public key (APK). In an embodiment of the invention, encryption-decryption module 206 decrypts the key ring by using at least one of the ALK and an administrative private key (APRK). The APRK is a private encryption key known only to administrators of the location protected data.

Further, control module 208 enables access to the location protected data. In another embodiment of the invention, control module 208 receives a location of the second computational device. Further, control module 208 can check whether the location of the second computational device is authorized to access the location protected data.

In yet another embodiment of the invention, control module 208 can generate at least one ALK corresponding to at least one authorized location while configuring access to the location protected data.

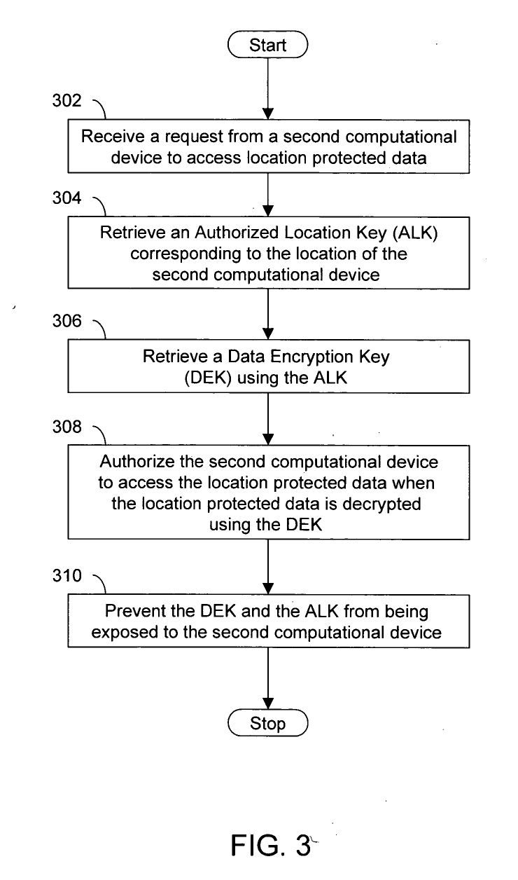

FIG. 3 is a flow diagram illustrating a method for managing access to location protected data on a first computational device, in accordance with an embodiment of the invention. At step 302, a request is received from a second computational device to access the location protected data stored at the first computational device. In an embodiment of the invention, the request can also be made automatically by a computer program or a software application.

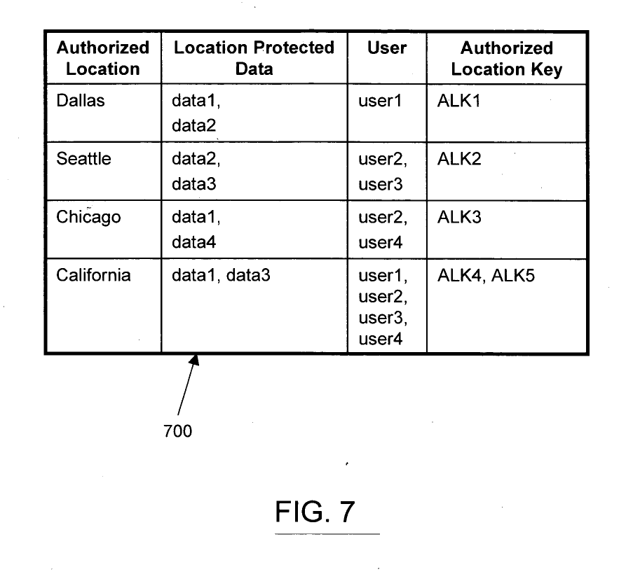

When the location of the second computational device is authorized to access the location protected data then, at step 304, an ALK corresponding to the location of the second computational device is retrieved from an authentication configuration table. The authentication configuration table is described in further details in conjunction with FIG. 7. The location of the second computational device can be received from a location provider situated at the location of the second computational device. For example, location provider 106c provides the location of computational device 104c. The location of the second computational device can include the details such as the latitude, the longitude and the altitude. The location may also include an area. For example, the geographical location of California can be defined in terms of the latitude, the longitude, and the altitude and the approximate radius around a reference point. For another example, the location may be within a fixed distance to the reference point.

Further, at step 306, the ALK is used to retrieve a DEK. The DEK is retrieved by decrypting a key ring by using the ALK. The key ring is described in further details in conjunction with FIG. 9. Thereafter, at step 308, the second computational device is authorized to access the location protected data by decrypting the location protected data using the DEK. At step 310, the DEK and the ALK are prevented from being exposed to the second computational device. The DEK and the ALK are stored such that the users of the second computational device are not exposed to them. For example, the ALK may be stored at a central server situated at a secured location in network 102. The DEK may be stored in a File Control Block (FCB) of the storage device of the first computational device. The FCB is a block in the storage device which stores information pertaining to file-structure. The file structure manages information pertaining to the files stored on the storage device. These files contain the location protected data.

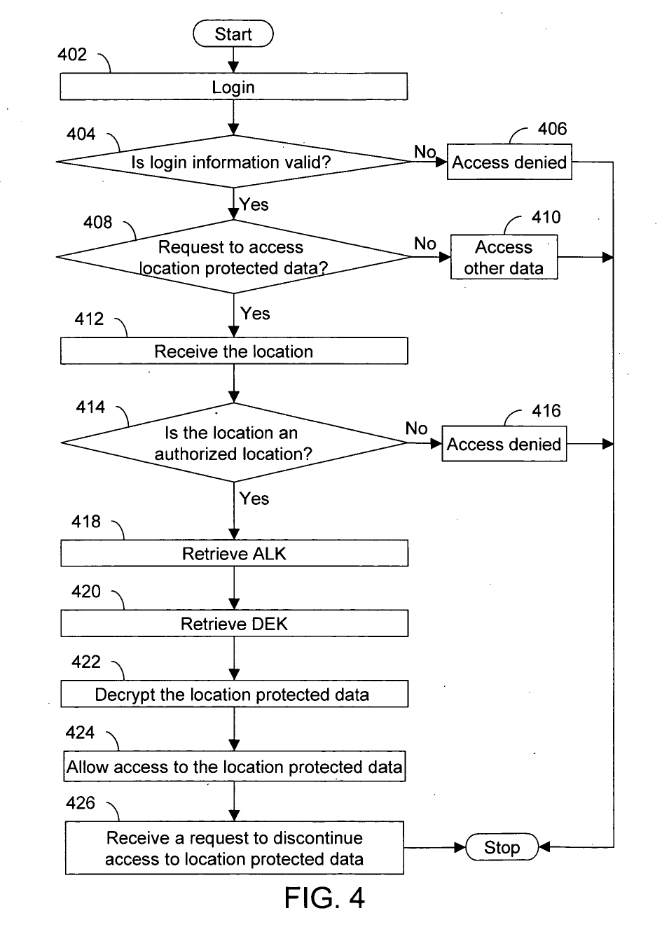

FIG. 4 is a flow diagram illustrating a method for managing access to location protected data on a first computational device, in accordance with another embodiment of the invention. At step 402, a user situated at a geographical location inputs the login information, such as a username and a password, to access a second computational device. In an embodiment of the invention the first and the second computational device may be the same. At step 404, it is checked if the login information provided by the user is valid. The validation of the login information can be done at the second computational device or any other network element in the network such as a server.

If the login information is invalid, then at step 406 the access to the second computational device is denied. If the login information is valid, step 408 is performed, and it is checked whether the user has made a request to access the location protected data. In an embodiment of the invention, the request can be made automatically by a computer program or a software application.

If the request is made to access unprotected data on the first computational device, then at step 410, the access to the unprotected data is allowed.

At step 412, the location of the second computational device is received from a location provider situated at the location of the second computational device. The location provider can receive its location from the GPS and communicate with the first computational device. The GPS can provide the location information of any object located at any geographical location. It should be noted that the location of the second computational device can be retrieved by using any other method as well.

At step 414, it is checked if location of the second computational device is validated against authorized locations from which the access to the location protected data is authorized. If the location of the second computational device is not an authorized location then, at step 416, access to the location protected data is denied. If the location of the second computational device is the authorized location then, step 418 is performed.

At step 418, an ALK corresponding to the location of the second computational device is retrieved from a authentication configuration table. The authentication configuration table is described in further details in conjunction with FIG. 7. Further, at step 420, a DEK corresponding to the location protected data is retrieved by decrypting a key ring. The key ring is described in further details in conjunction with FIG. 9. The key ring is decrypted by using the ALK. In an embodiment of the invention, at least one APRK may be used to retrieve the DEK by decrypting the key ring. The APRK is a private key known only to an administrator of the location protected data. In another embodiment of the invention, either an ALK or an APRK is used to decrypt the key ring to retrieve the DEK. Thereafter, at step 422, the location protected data is decrypted by using the DEK. Once the location protected data is decrypted, the user of the second computational device is allowed to access the location protected data at step 424.

In an embodiment of the invention DEKs and ALKs are changed at a preconfigured interval by using various randomization techniques known in the art. This ensures that the previously used DEKs and ALKs are not reused to access the location protected data from an unauthorized location.

In an embodiment of the invention, when access to the location protected data is allowed, the location of the second computational device is checked periodically to ensure that the second computational device has not moved out of the authorized location.

At step 426, a request is received to discontinue access to location protected data. Thereafter, access to the location protected data is stopped.

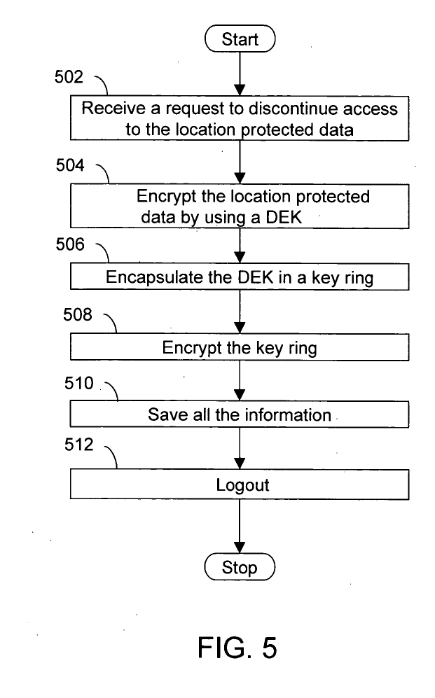

FIG. 5 is a flow diagram illustrating a method for terminating access to location protected data on a first computational device, in an embodiment of the invention. At step 502, a request is received from the second computational device to terminate access to the location protected data on the first computational device. At step 504, the location protected data is encrypted using a DEK. At step 506, the DEK is encapsulated in a key ring. The key ring is described in further details in conjunction with FIG. 9. At step 508, the key ring is encrypted using at least one APK. In an embodiment of the invention the key ring may be encrypted by using at least one ALK. In an embodiment of the invention at least one of previously used DEK and ALK are changed and replaced with newly generated DEK and ALK, respectively. The ALK and DEK may be generated using one of the randomization techniques known in the art. The DEK and ALK are stored such that the users of the second computational device are not exposed to them. For example, an ALK can be stored at a central server situated at a secured location in network 102. The DEK can be stored in a File Control Block (FCB) of the storage device of the first computational device encrypted with ALKs and APK. The FCB is a block in the storage device which stores information pertaining to file-structure. The file structure manages information pertaining to the files stored on the storage device. These files contain the location protected data. At step 510, all the information is saved and, at step 512, access to the location protected data is terminated and the user of the second computational device is logged out.

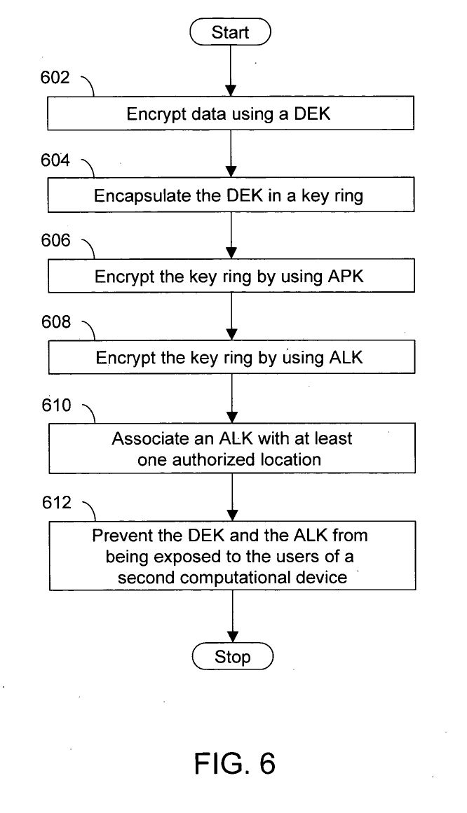

FIG. 6 is a flow diagram illustrating a method for configuring access to location protected data, in accordance with an embodiment of the invention. The location protected data is stored on a storage device. The storage device is connected to a first computational device. The location protected data is configured to restrict access to the location protected data from unauthorized locations. Once access to the location protected data is configured, the location protected data could only be accessed from authorized locations by authorized users.

An administrator selects at least one set of data stored on the storage device to configure it. The data may include financial data, client data, employee data, research related data, military information and the like.

In an embodiment of the invention the administrator may select a partition of the storage device to configure all the data stored on the partition as location protected data. At least one DEK is generated corresponding to the at least one set of data by using one of the randomization techniques known in the art. At step 602, the location protected data is encrypted by using the at least one DEK. At step 604, the DEK is encapsulated in a key ring. The key ring is described in further details in conjunction with FIG. 9. At step 606, at least one APK is used to encrypt the key ring. The key ring encrypted by using the at least one APK can be decrypted by using at least one APRK. Further, at step 608, the key ring is encrypted by using at least one ALK.

The ALK is generated corresponding to each authorized location by using various randomization techniques known in the art. An authorized location is the location for which authorization to access the location protected data is to be given. At step 610, at least one ALK is associated with at least one authorized location. The authorized locations may be stored in a database, in a configuration file and the like.

At step 612, DEK and ALK are prevented from being exposed to the users of the second computational device. ALKs are stored in an authentication configuration table. The authentication configuration table is described in further details in conjunction with FIG. 7. The authentication configuration table may be stored at a central server located at a secured location in network 102. In an embodiment of the invention the authentication configuration table may be stored at the first computational device. Only the administrator has access to the central server and hence to ALKs. Similarly, DEK is encapsulated in the key ring and stored in a file control block of the storage device. The user can not access the DEK without the use of the at least one ALK. When the storage device is stolen or lost, then also no one can access the location protected data as the location protected data is encrypted and DEK is not accessible. Other than the ALK, only an APRK can be used to retrieve the DEK used to encrypt the location protected data. The APRK is known only to an administrator of the location protected data. Therefore, the APRK is also not exposed to the users of the second computational device.

In accordance with another embodiment of the invention, the administrator may reconfigure the location protected data on the storage device, based on modified information corresponding to authorized locations. For example, the administrator may add new authorized locations. Further, the administrator may remove authorization of one or more previously authorized locations to access the location protected data.

FIG. 7 illustrates an exemplary authentication configuration table 700, in accordance with an embodiment of the invention. It should be noted that authentication configuration table 700 can include additional or lesser information than that is described.

Authentication configuration table 700 maintains information about ALKs, authorized locations, location protected data and information about the users authorized to access the location protected data. Authentication configuration table 700 may be stored at a central server located at a secured location in network 102. Access to the central server is restricted. In an embodiment of the invention, authentication configuration table 700 may be stored on the first computational device at which the location protected data is stored. The users of the second computational device do not have access to authentication configuration table 700. Authentication configuration table 700 shows that only user1 can access both data1 and data2 from Dallas and ALK1 corresponds to Dallas. Moreover, it is apparent that user1 is authorized to access the location protected data only from Dallas and California and not from Seattle and Chicago.

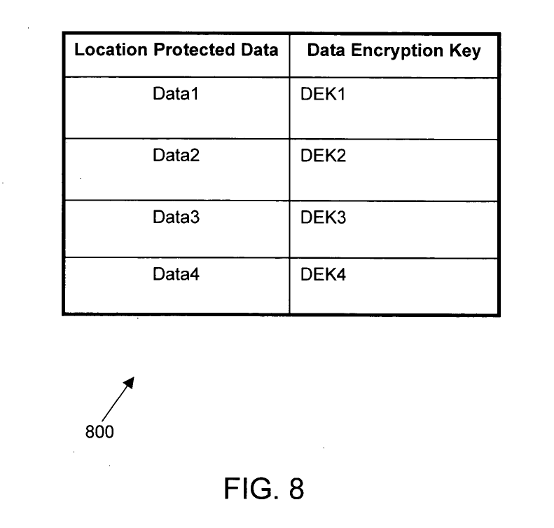

Similarly, authentication configuration table 700 shows that only user2 and user3 can access both data2 and data3 from Seattle and ALK2 corresponds to Seattle. User2 and user4 can access both data1 and data4 from Chicago and ALK3 corresponds to Chicago. User1, user2, user3 and user4 can access both data1 and data3 from California and ALK4 and ALK5 corresponds to California. ALKs are used to retrieve DEK to decrypt the location protected data. This is explained in further details in conjunction with FIG. 8.

FIG. 8 illustrates an exemplary key table 800, in accordance with an embodiment of the invention. Key table 800 shows DEKs corresponding to the location protected data. Key table 800 shows that data1 is encrypted by using DEK1 and can be decrypted by using only DEK1. Similarly, data2 is encrypted by using DEK2 and can be decrypted by using only DEK2. Data3 is encrypted with DEK2 and can be decrypted by using only DEK3. Data4 is encrypted with DEK4 and can be decrypted by using only DEK4.

DEKs are encapsulated in key rings and stored in a file control block of a storage device of the first computational device. Users of the second computational device can not access DEKs without the use of at least one of, an APRK and an ALK.

FIG. 9 illustrates an exemplary key ring 900, in accordance with an embodiment of the invention. Key ring 900 encapsulates a DEK. Key ring 900 is encrypted by using at least one APK. In an embodiment of the invention key ring 900 is also encrypted by using at least one ALK.

As shown in FIG. 9, key ring 900 is encrypted by using an APK, ALK1, and ALK2. Further, the DEK can only be retrieved by using at least one of an APRK, ALK1, and ALK2. ALK1 and ALK2 correspond to Dallas and Seattle respectively as shown in authentication configuration table 700. Therefore, ALK1 is used to retrieve the DEK to decrypt a location protected data to access it from Dallas. For example, the DEK shown in key ring 900 may correspond to DEK1 shown in key table 800. The DEK may be used to decrypt data1, if the DEK corresponds to DEK1. Similarly, the DEK may be used to decrypt data2, if the DEK corresponds to DEK2.

The method and system of the present invention or any of its components may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer also comprises a microprocessor, which is connected to a communication bus. The computer also includes a memory, which may include Random Access Memory (RAM) and Read Only Memory (ROM). Further, the computer system is connected to a storage device, which can be a hard disk or a removable storage such as a floppy disk, optical disk, a flash card, a magnetic tape, etc. The storage device can also be other similar means for loading computer programs or other instructions into the computer system. The storage device can either be directly or remotely connected to the computer system. The computer system also includes a communication unit, which allows the computer to connect to other databases and the Internet through an I/O interface. The communication unit allows the transfer and reception of data from other databases. The communication unit may include a modem, an Ethernet card, or any similar device that enables the computer system to connect to databases and networks such as LAN, MAN, WAN, and the Internet. The computer system facilitates inputs from a user through an input device that is accessible to the system through an I/O interface.

The computer system executes a set of instructions that are stored in one or more storage elements, to process input data. The storage elements may hold data or other information, as desired, and may also be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program, or a portion of a program module, as in the present invention. The software may also include modular programming in the form of object-oriented programming. Processing of input data by the processing machine may be in response to user commands, the result of previous processing, or a request made by another processing machine.

The method and system provided in the present invention restricts unauthorized access to data stored on a data-storage device connected to a first computational device from an unauthorized location. Further, the method and system restricts direct access to DEKs, which are changed randomly at regular intervals.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for managing access to location protected data on a first computational device, the method comprising the steps of:
a) receiving a request to access the location protected data, the request being received from a second computational device;
b) retrieving an authorized location key corresponding to a location of the second computational device when the location of the second computational device is an authorized location;
c) retrieving a data encryption key by using the authorized location key;
d) authorizing the second computational device to access the location protected data, the location protected data being decrypted by using the data encryption key; and
e) preventing the data encryption key and the authorized location key from being exposed to the second computational device.

2. The method according to claim 1 further comprising the step of changing at least one of the data encryption key and the authorized location key by using randomization techniques at preconfigured intervals.

3. The method according to claim 1 further comprising the step of changing at least one of the data encryption key and the authorized location key by using randomization techniques when access to the location protected data is discontinued.

4. The method according to claim 1 further comprising the step of encrypting the location protected data using the data encryption key when access to the location protected data is discontinued.

5. The method according to claim 1 further comprising the steps of:
a) encapsulating the data encryption key in a key ring when access to the location protected data is discontinued;
b) encrypting the key ring by using an administrative public key; and
c) encrypting the key ring by using at least one authorized location key.

6. The method according to claim 1, wherein the location of the second computational device is retrieved by using a Global Positioning System (GPS).

7. The method according to claim 6 further comprising the step of re-retrieving the location of the second computational device at a preconfigured interval to enable the second computational device to continue to access the location protected data.

8. The method according to claim 1, wherein the first computational device and the second computational device are the same.

9. A method for configuring access to location protected data on a first computational device, the method comprising the steps of:
a) encrypting the location protected data by using a data encryption key;
b) encapsulating the data encryption key in a key ring;
c) encrypting the key ring by using an administrative public key;
d) encrypting the key ring by using at least one authorized location key;
e) associating the at least one authorized location key with at least one authorized location, access to the data being authorized from the at least one authorized location; and
f) preventing the data encryption key, and the authorized location key from being exposed to the users of a second computational device who try to access the location protected data.

10. The method according to claim 9, wherein the first computational device and the second computational device are the same.

11. A data protection system for managing access to location protected data on a first computational device, the system comprising:
a) a request receiving module, the request receiving module receiving a request from a second computational device to access the location protected data;
b) a key-retrieving module, the key-retrieving module retrieving an authorized location key corresponding to a location of the second computational device when the location of the second computational device is an authorized location, access to the data being authorized from the authorized location, the authorized location key being used to retrieve a data encryption key;
c) an encryption-decryption module, the encryption-decryption module decrypting the location protected data by using the data encryption key;
d) a control module, the control module enabling access to the location protected data; and
e) means for preventing the data encryption key and the authorized location key from being exposed to the second computational device.

12. The data protection system according to claim 11, wherein the key-retrieving module further retrieves the data encryption key.

13. The data protection system according to claim 11, wherein the encryption-decryption module further encrypts the location protected data.

14. The data protection system according to claim 11, wherein the encryption-decryption module further encrypts a key ring that encapsulates the data encryption key, encryption being done by using an authorized location key and an administrative public key.

15. The data protection system according to claim 11, wherein the encryption-decryption module decrypts a key ring that encapsulates the data encryption key, decryption being done by using at least one of an administrative private key and the authorized location key.

16. The data protection system according to claim 11, wherein the control module further receives the location of the second computational device.

17. The data protection system according to claim 11, wherein the control module further checks whether the location of the second computational device is an authorized location.

18. The data protection system according to claim 11, wherein the control module further generates at least one authorized location key corresponding to at least one authorized location.

19. A computer program product for use with a computer stored program, the computer program product comprising a computer readable medium having a computer readable program code embodied therein for managing access to location protected data on a first computational device, the computer readable program code including instructions for:
a) receiving a request to access the location protected data, the request being received from a second computational device;
b) retrieving an authorized location key corresponding to a location of the second computational device when the location of the second computational device is an authorized location;
c) retrieving a data encryption key by using the authorized location key;
d) authorizing the second computational device to access the location protected data, the location protected data being decrypted by using the data encryption key; and
e) preventing the data encryption key and the authorized location key from being exposed to the second computational device.

20. A computer program product for use with a computer stored program, the computer program product comprising a computer readable medium having a computer readable program code embodied therein for configuring access to data on a first computational device, the computer readable program code including instructions for:
a) encrypting the location protected data by using a data encryption key;
b) encapsulating the data encryption key in a key ring;
c) encrypting the key ring by using an administrative public key;
d) encrypting the key ring by using at least one authorized location key;
e) associating the at least one authorized location key with at least one authorized location, access to the data being authorized from the at least one authorized location; and
f) preventing the data encryption key, and the authorized location key from being exposed to the users of a second computational device who try to access the location protected data.
